(19) United States
(12) Patent Application Publication
(10) Pub. No.: US 2019/0139125 A1
(43) Pub. Date: May 9, 2019

(54) SYSTEM AND METHOD FOR COMMUNITY-BASED VIRTUAL STORES

(71) Applicant: Eugenio s. YNION, JR., San Pedro City (PH)

(72) Inventor: Eugenio S. YNION, JR., San Pedro City (PH)

(21) Appl. No.: 16/182,484

(22) Filed: Nov. 6, 2018

Related U.S. Application Data
(60) Provisional application No. 62/582,748, filed on Nov. 7, 2017.
(60) Provisional application No. 62/756,445, filed on Nov. 6, 2018.

(51) Int. Cl. G06Q 30/06; G06Q 10/08; G06Q 20/20

(52) U.S. Cl. CPC G06Q 30/0635; G06Q 10/087; G06Q 20/20; G06Q 30/0641; G06Q 10/0833; G06Q 30/0625; G06Q 10/0834

(57) ABSTRACT

The present invention is in the field of online e-commerce and relates to a system, device, and method for allowing the automated determination of the nearest source of the virtual store and delivery mechanism in order to fulfill the online purchase by providing intelligence to the online e-commerce experience of consumers.

### CROSS-REFERENCE TO RELATED APPLICATION

The present nonprovisional application claims the benefit of U.S. Provisional Application No. 62/582,748 filed on Nov. 7, 2017 and 62/756,445 filed on Nov. 6, 2018 and incorporates the same by reference.

### FIELD OF THE INVENTION

The present invention is in the field of online e-commerce and relates to a system, device, method, and computer program product for allowing an automated determination of the nearest product source for a virtual store, and a delivery mechanism in order to fulfill an online purchase by providing intelligence to the online e-commerce experience of consumers.

### BACKGROUND OF THE INVENTION

One way of grocery shopping is to physically go to a grocery store, pick out desired items, purchase them, and carry them home. However, this can be inconvenient and time consuming. Severe congestion of people and vehicles in most cities and suburban commercial and residential areas, for example, can make it quite challenging to move around quickly and conveniently. In addition, it can be difficult to physically go to a grocery store because families, especially those family members who work outside the home, usually spend from 10 to 12 hours at their respective work places. Grocery stores are normally located relatively far away from many homes, thereby requiring the need to use either public transportation or the family's private vehicle, with parking increasingly becoming costly and difficult to find. Furthermore, the price of commodities can be significantly higher at major supermarkets and convenience stores due to their traditional sources of goods—e.g., too many middle actors in the supply chain.

In current online shopping systems, the geo-tagging of the various actors/personas in the shopping process is normally done separately and in a non-integrated manner. Commonly there is no geo-tag or location information provided in real-time and reflected in a digital platform. The absence of geo-tagged data/information provided in real-time in a single digital platform is perhaps the biggest challenge and limitation of existing practices in the logistics and in the consumer shopping industries.

An online shopper can search the Internet to find hundreds or thousands of online stores or mediums which will appear in the search in the search results. Which one to use can be a challenge and a user would normally go to familiar sites such as Amazon® or others. Once the shopper enters a specific online store or retail outlet, e.g. Amazon®, even if the location of the shopper is pre-identified as being within the zip code of the shopper, there are still many items in the Amazon® site which get presented to the online shopper. The shopper can have the items delivered or can opt for an in-store pick-up based on a specific date and time. However, conventional online platforms presents so many options to the shopper that he or she will often spend a significant amount of time choosing an item among them.

The “too many options” problem becomes a critical issue without geo-tagged or specific location data/information. For example, skin care products that perfectly fit those in North America will not necessarily work or be effective for people in Asia due to various scientific reasons pertaining to the climate and such. Thus, the automated ability of a digital platform to determine and offer appropriate products based on location/geo-tagged information is critical. As another example, a certain product might be more expensive in certain parts of a country but if the factory of that product is near a certain community the pricing can be much lower (e.g. petroleum products).

The present invention provides solution to the abovementioned and other problems.

### BRIEF SUMMARY OF THE INVENTION

In another aspect, there is provided a non-transitory computer-readable storage medium storing a program, which, when executed by the above mentioned system, performs the following steps: receiving by the server an order from the user device; sending by the server order information to the virtual store device and the driver device; updating by the Geo-Tag module locations of driver devices in real-time in the data storage; and displaying on the user device a location of a virtual store using the virtual store device, a current location of the driver device, and a target address.

In one embodiment, there is provided a system for community-based virtual stores, comprising: a server, the server comprising (i) at least one processor, (ii) a data storage, (iii) a geo-tag module, and (iv) a device communication module, wherein the geo-tag module is configured to keep track of current locations of driver devices. The device communication module is configured to receive a search request and an order from a user device, select a driver who would pick up an ordered item from a virtual store and deliver the ordered item to a target address based at least on order details and driver locations, send order details to a driver device of a selected driver and to a virtual store device of the virtual store, receive a driver confirmation from the selected driver, and reselect another driver if the driver confirmation indicates that the selected driver cannot deliver the ordered item based at least on order details and driver locations.

In another embodiment, the system further comprises a virtual store device, wherein the virtual store device is configured to generate an inventory update when receiving an input from a user and send the inventory update to the server. The server is configured to update the data storage according to the inventory update.

Preferably, the virtual store device is further configured to receive store information from the user and send the store information to the server, wherein the server is configured to update the data storage to reflect according to the store information.

In a preferred embodiment, the virtual store device is further configured to receive a Point-of-Sale (POS) order and sends a POS transaction information to the server.

In another preferred embodiment, the virtual store device is further configured to receive the order details from the server, and send a confirmation that the selected driver pricked up the order item to the server.

The system may further comprise a driver device, wherein the driver device is configured to receive driver information from a driver, wherein the driver information comprises a name, a plate number, a mobile number, and a phone serial number, and send the driver information to the server.

In one embodiment, the driver device is further configured to receive the order details from the server, and display the order details and options for the selected driver to select whether the selected driver can take this order.

In yet another embodiment, the driver device is further configured to: display a map and/or instruction for picking up the ordered item and deliver the order item to the target address, and update a location of the driver device in real-time.

In still another embodiment, the system further comprises a user device, wherein the user device is configured to: provide two search options, the two search options including a location search and an item search, and send a search request inputted by the user to the server.

Alternatively, the user device is further configured to: display a list of items that are similar to an item related to a keyword in the search request when the item search is chosen, and display a map showing virtual stores near a location related to the keyword in the search request when the location search is chosen.

In still another preferred embodiment, the user device is further configured to send order details to the server, and receive delivery updates from the server.

In another aspect of the invention, there is provided a method for community-based virtual stores, comprising: (i) receiving by a server a search request for an item from a user device;(ii) determining by the server which nearby virtual stores have items related to the item search request and providing a list of items related to the item search request to the user device; (iii) receiving by the sever a search request for a location from the user device; (iv) sending by the server information of nearby stores related to the location search request to the user device; and (v) sending by the server a list of items a selected virtual store has to the user device.

Preferably, the method further comprises: receiving by a server having at least one processor and a data storage order details from the user device; selecting by the server a driver who would pick up an ordered item or ordered items from a virtual store or virtual store(s) to a target address according the order details, based at least on current locations of drivers; sending the order details to a driver device of a selected driver; and reselecting by the sever another driver when the selected driver sends a confirmation that the selected driver cannot deliver the ordered item(s) based at least on the current locations of drivers.

In another embodiment, the method further comprises sending by the server the order details to a virtual store device of virtual store(s) according to the order details.

In a preferred embodiment, the method further comprises updating the storage according to the order details.

In another aspect, there is provided a non-transitory computer-readable storage medium storing a program, which, when executed by the system for community-based virtual stores performs the following steps: (i) receiving by the server an order from a user device; (ii) sending by the server order details to a virtual store device and a driver device; (iii) updating by the Geo-Tag module locations of driver devices in real-time in the data storage; and (iv) displaying on the user device a location of a virtual store, a current location of the driver device, and a target address.

### BRIEF DESCRIPTION OF THE DRAWINGS

FIG. 1 is an exemplary block diagram of a system according to one embodiment.

FIG. 2A is an exemplary screen for a user device showing a map on which current locations of participants are shown according to one embodiment.

FIG. 2B is an exemplary screen for a user device showing order tracking according to one embodiment.

FIG. 2C is an exemplary screen for a user device showing a map on which the location of the driver delivering an item purchased is shown according to one embodiment.

FIG. 3A is an exemplary screen for a driver device showing instructions for the driver according to one embodiment.

FIG. 3B is an exemplary screen for a driver device showing a direction, stores to drop by, and a user's address according to one embodiment.

FIG. 3C is an exemplary screen for a driver device showing a payment method, and options for terminating the delivery order according to one embodiment.

FIG. 4A is an exemplary screen for a virtual store device showing store information according to one embodiment.

FIG. 4B is an exemplary screen for a virtual store device showing items in the inventory according to one embodiment.

FIG. 4C is an exemplary screen for a virtual store device showing scanning function of an app provided to the virtual store according to one embodiment.

FIG. 5 is an exemplary flowchart of a consumer transaction according to one embodiment.

FIG. 6 is an exemplary flowchart of a retailer transaction according to one embodiment.

FIG. 7 an exemplary implementation of the system using the Amazon Web Services (AWS) according to one embodiment.

FIG. 8 is a flowchart of an online sale for the device communication module 116 of the server 127 according to an exemplary embodiment.

FIG. 9 is a flow chart for the virtual store device 101 according to an exemplary embodiment.

FIG. 10 is a flow chart for the driver device 103 according to an exemplary embodiment.

FIG. 11 is a flow chart for the user device 105 according to an exemplary embodiment.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as, for example, methods, systems, devices, or computer program products. Accordingly, embodiments may take the form of a hardware implementation, an entirely software implementation, or an implementation combining software and hardware aspects. The following detailed description is therefore not to be taken in a limiting sense.

The present disclosure provides a solution to a traditional problem, and may be implemented using a combination of hardware, software, and mobile apps including in one example aspect a computer program called “LittleGrocers,” which gives intelligence to the e-commerce experience to consumers. Such intelligence allows the automated determination of the nearest source of the virtual store and delivery mechanism in order to fulfill an online purchase.

The experience is also made quite interesting through the use of computer animation and related “gamification” techniques to create never ending or unlimited excitement, every day on a 24/7 basis if desired. The present disclosure further discloses in one aspect a solution to a technical challenge to locate and coordinate all the various participants of day-to-day transactions in an efficient and fast manner in real-time.

Pricing is a function of many factors but the most basic is based on the law of supply and demand. The invention has a social advocacy angle behind it and it aims to empower the ordinary house-hold or families to establish a small business through LittleGrocers' “virtual store.”

A “virtual store” as used herein may include an informal business establishment that has no “brick and mortar” physical store, no formal organization and none of the usual capital investments on infrastructure. A “virtual store” may be a person with access to LittleGrocers web/mobile app (software) and a certain amount of inventory items purchased online at LittleGrocers for the purpose of selling them to their specific “target market.” “Target market” refers to the buyers located near the vicinity of the “virtual store.” Easy, fast, efficient, and secure delivery of the items can be made through the LittleGrocers' web/mobile app (software). Ultimately, the overall setup of LittleGrocers can create the best possible prices of its products and services.

The major components or actors in the purchase of goods from LittleGrocers comprise the following: a. Buyer, b. Seller, c. Goods to be purchased, d. Deliverer, e. a Server coordinating all of this. The normal process or method of coordinating all the actors/components above may be integrated in one system or implemented as separate silos of systems, and coordination can be done either in an automated computerized manner or by simple manual coordination. One aspect of the present invention is a fully integrated software product which implements its proprietary technologies to achieve a seamless collaboration of both Data/Information together with all the actors and components in the shopping process.

In one embodiment, the system is configured to determine the physical location of the various actors/participants/items/components in the shopping process, integrate the interaction among these actors/items/components in a common Internet-based digital platform (for example), and implement “virtual stores” to dramatically establish the most cost and time efficient “last mile” logistics delivery. The present disclosure in one embodiment discloses a digital platform which provides real-time geo-tagged or location information across its entire platform.

One aspect of the community-based virtual stores may be a system for allowing the automated determination of the nearest source of the virtual store and delivery mechanism in order to fulfill an online purchase by providing intelligence to the online e-commerce experience of consumers. The system may comprise a server, a device for a virtual store, a device for a driver, and a device for a user.

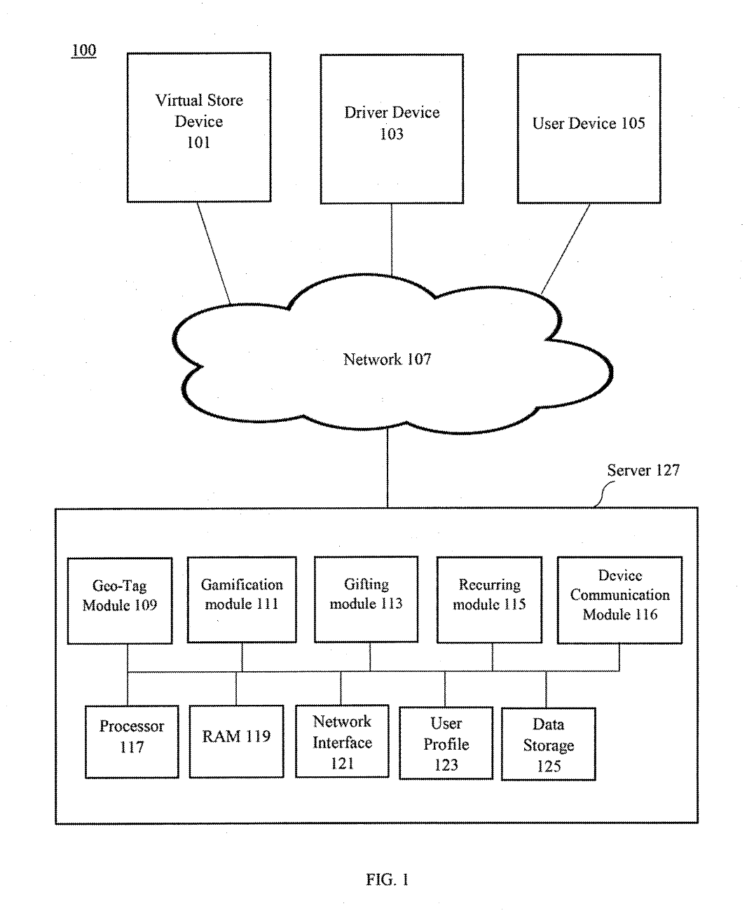

Referring to FIG. 1, there is seen an exemplary block diagram showing a system 100 for community-based virtual stores according to one embodiment of the invention. The system 100 may comprise a virtual store device 101, a driver device 103, a user device 105, and a server 127. The driver device 103 may be a handheld device (e.g., phone or tablet or others) that has an app or software downloaded thereon. The virtual store device 101 and the user device 105 may be a phone or tablet or others having a Point-of-Sale app or software downloaded thereon. The server 127 comprises a processor 117, memory 119, and data storage 125 including a user profile database 123 as well as various modules (including but not limited to a Geo-Tag module 109, a gamification module 111, a gifting module 113, a recurring module 115, and a device communication module 116) for carrying out the functions of the software. The server 127 may be a server computer but it is not limited to this; it can be for example a workstation, a router, a personal computer, a portable computer, a microprocessor-based entertainment appliance, a peer device, or any other common network node. A virtual store, a driver, and a user may access the system using the virtual store device 101, driver device 103, and user device 105, respectively. These devices may be any computing device capable of connecting to a network. Example computing devices include, but are not limited to, a mobile telephone, a smart phone, a tablet, a phablet, a smart watch, a wearable computer, a personal computer, a desktop computer, a laptop computer, a gaming device/computer, a television, and the like.

Still referring to FIG. 1, the virtual store device 101, the driver device 103, the user device 105, and the server 127 are connected via network 107. The processor 117 can be any of various commercially available processors. Dual microprocessors and other multi-processor architectures may also be employed as the processor 117. The data storage 125 can include both volatile and nonvolatile memory, removable and non-removable media implemented in any method or technology for storage of information such as computer-readable instructions, data structures, program modules, or other data. The data storage includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by a computer.

As shown in FIG. 1, there various modules in the system are shown. Other modules may be added or replaced. The Geo-Tag module 109 may be configured to (1) keep track of locations of virtual stores, drivers, and users, and (2) calculate routes for drivers to pick up an item or items from a virtual store or virtual stores and deliver them to a user's address.

The gamification module 111 may be configured to display a sound and/or graphic, such as a character or characters moving or dancing when a certain event is triggered by users. In one embodiment, the gamification module 111 employs computer games-related techniques in the form of user interface screens and using computer animation (e.g. avatars) to create an exciting experience for its users.

The gifting module 113 may be configured to provide packing options for users, so recipients can receive a “well-packaged” set of goods in the form of a gift. Users may be prompted to have the product delivered in gift form and the server 127 facilitate that by making arrangements with a gift wrapping entity.

The recurring module 115 may be configured to automatically place a recurring order, e.g., weekly, bi-weekly, or monthly basis, as per users' choice. The system may employ the use of “recurring” orders or a pre-arranged list of goods to be delivered to its recipient on a regular basis which had been memorized/recorded in LittleGrocers. The recurring module 115 may prompt a user to select whether the user wishes to have an order placed at predetermined intervals.

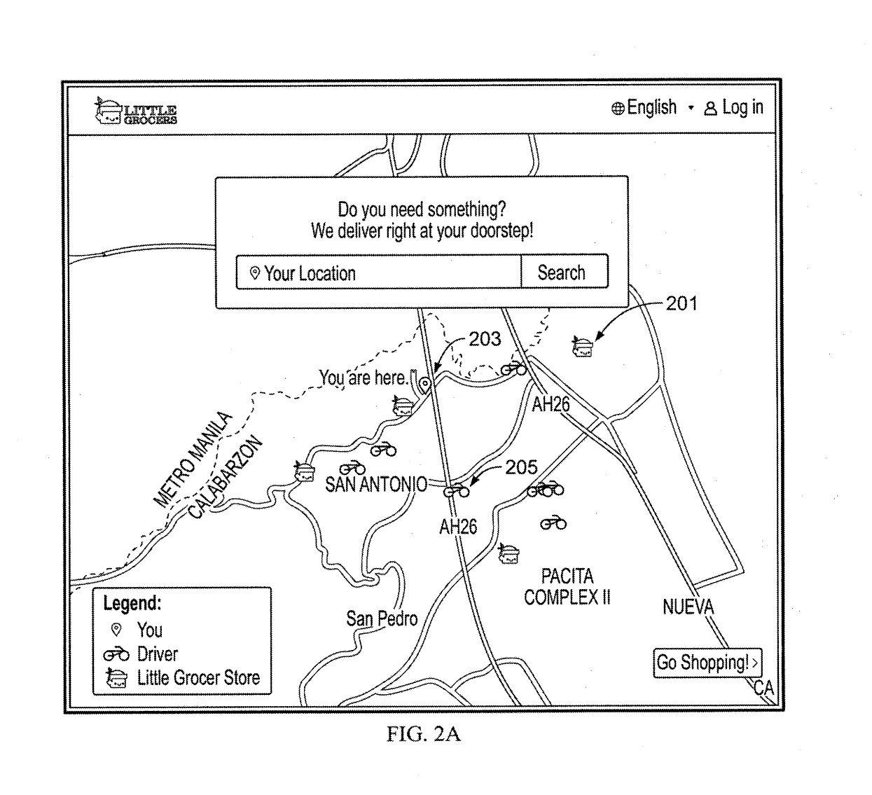

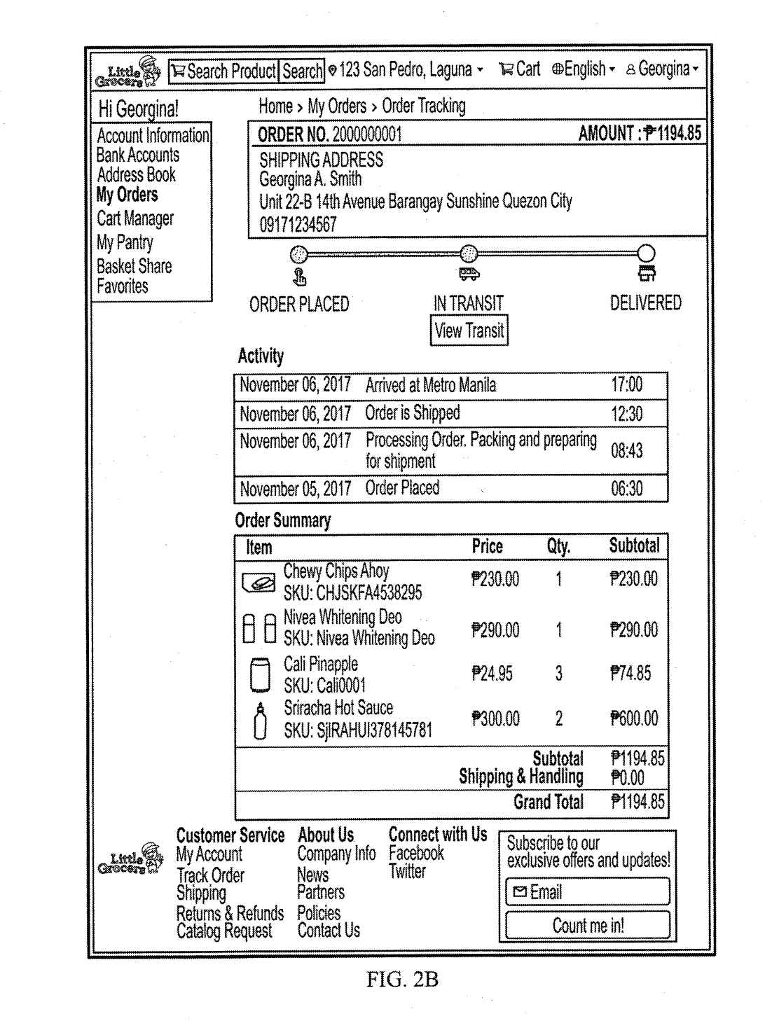

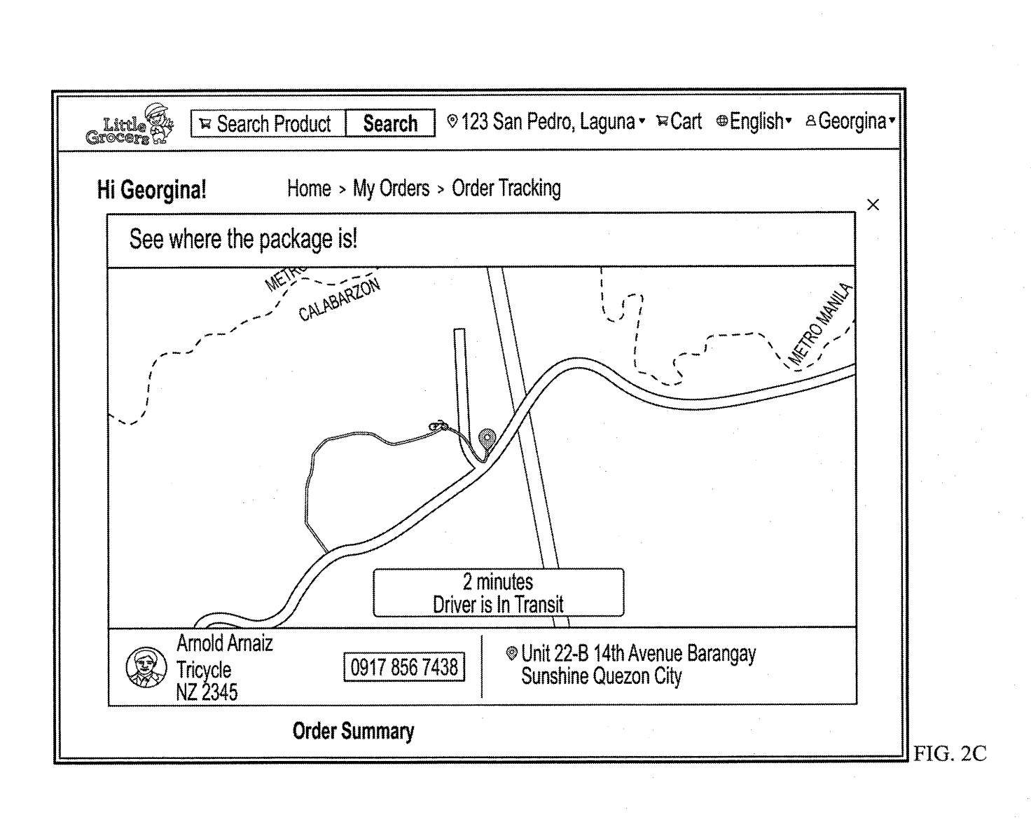

Users, drivers, and virtual stores may register with and log into LittleGrocers in a conventional way. A user using the user device 105 may access the server 127 through the network 107 and look up on a webpage displayed by the server 127 items he or she wants to buy or nearby virtual stores that are registered with the system. The user may view registered virtual stores and registered drivers in real-time on a map as shown in FIG. 2A. The user's location 203 may be determined by information provided the user or his or her location information collected from a GPS device, a router, a mobile phone, or the like. The Geo-Tag module 109 may be configured, using for example GPS, to update and store the location information of users 203, virtual stores 201, and drivers 205 in the data storage 125 and to display the current locations of the user 203, virtual stores 201, and drivers 205 on a map.

The user may choose items, delivery options, and payment options to place an order. The delivery options may include express (basic delivery with no tracking of order), standard (basic vehicle type with order tracking), and premium (better vehicle type with order tracking, with items handled with care). The user may view the user device 105 to see the purchase history/status of items as shown for example in FIG. 2B. FIG. 2B is an exemplary webpage for order tracking for a user according to one embodiment of the invention. The webpage for order tracking may comprise an activity log that shows dates, times, and activities related to the purchase. The webpage for order tracking may also have an option to show a transit in real-time. When the user clicks on “View Transit,” a new screen may be displayed as shown in FIG. 2C.

Referring to FIG. 2C, there is seen a map on which the location of the driver and the user are shown according to one embodiment of the invention. The user may view on the user device 105 the location of the driver device 103 in real-time, the name and photo of the driver, the type of the vehicle, the plate number of the vehicle, and the contact information of the driver device 103.

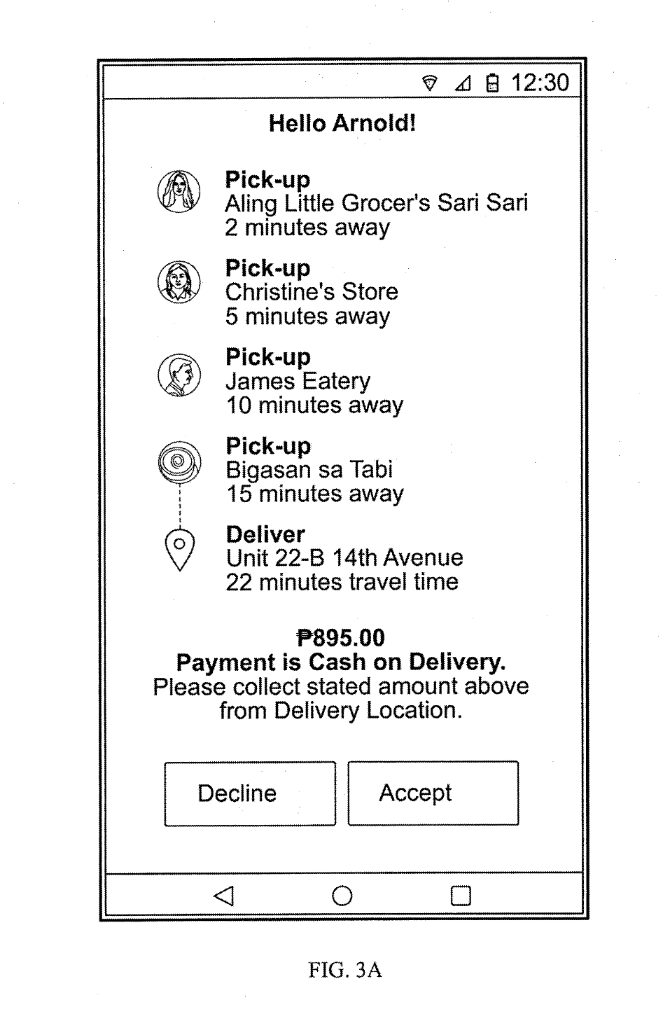

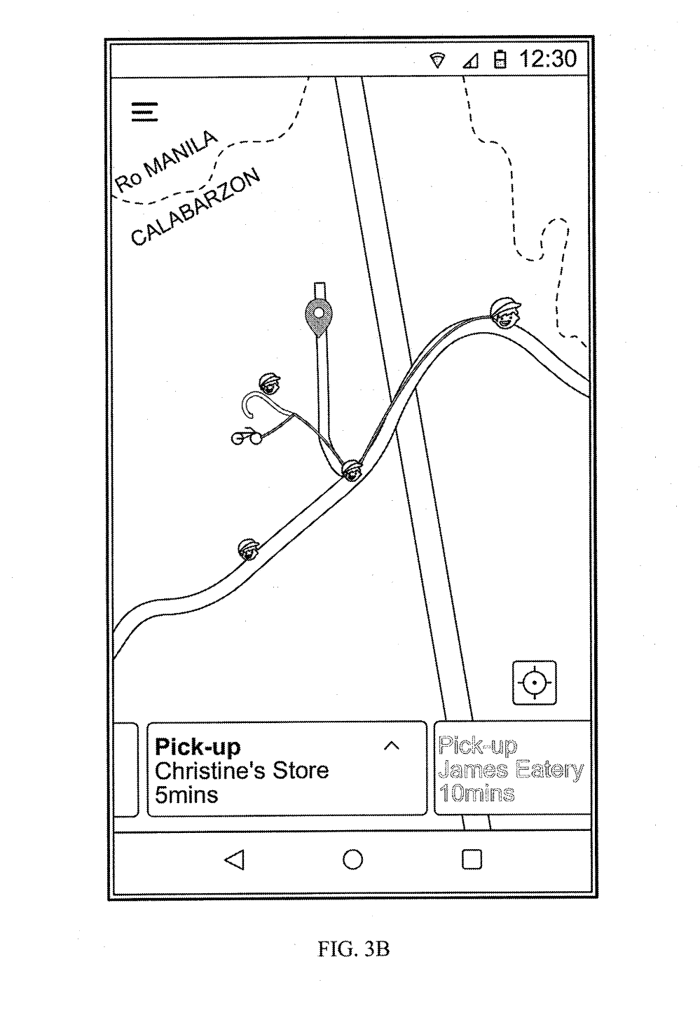

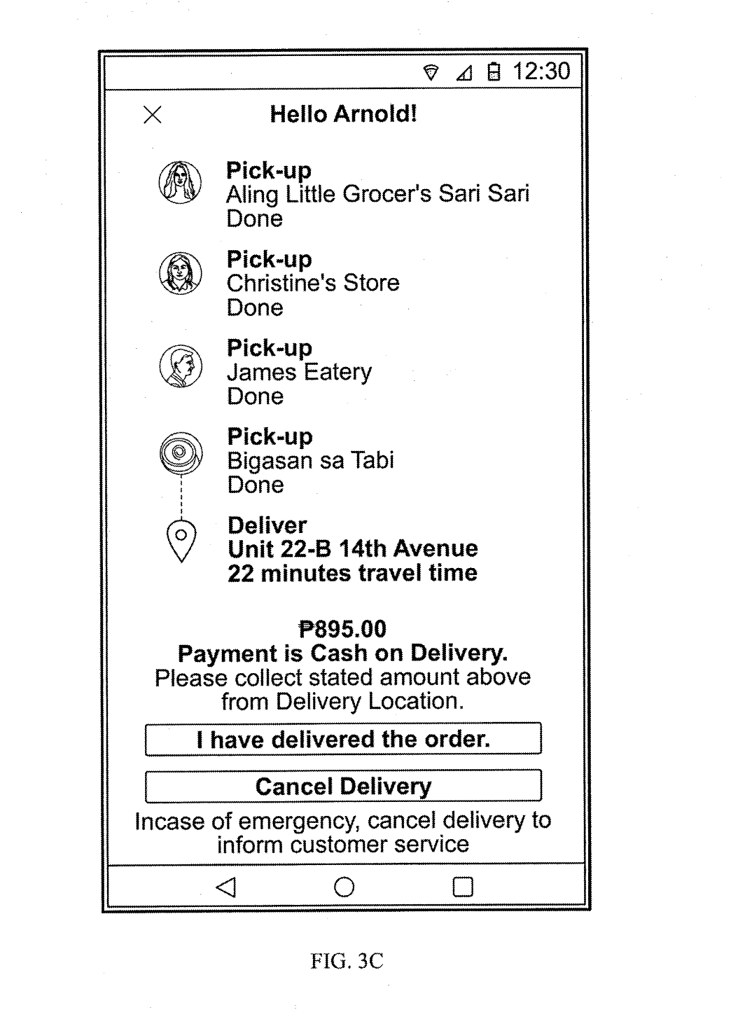

In FIGS. 3A-3B, there is seen exemplary screens displayed on the driver device 103 according to one embodiment of the invention. As an example, when the user places an order to buy four items from four different virtual stores, the Geo-Tag module 109 determines which driver is available and which driver may deliver the items quickly and safely. When determining this, factors such as drivers' locations and review points may be considered. A team of accredited delivery drivers may use various types of community-based delivery vehicles such as a bicycle, a motorcycle, a tricycle, a mini-van, and others. Each driver has a LittleGrocers App or software on his or her driver device 103 that which allows him/her to receive customer orders and other forms of instructions.

Then the server 127 sends order information to the driver device 103. The driver device 103 may receive information regarding pick-ups and delivery from the server 127 and display them as shown in FIG. 3A. Text or SMS (short message service) alerts, for example, may be used to pass messages (important or otherwise) or induce action to concerned participants in the online shopping experience. The driver device 103 may showing each virtual store the driver should drop by to pick up items and a target address (the user's address), as shown in FIG. 3B. The map may be updated, e.g., as the location of the driver changes or the delivery order changes.

When the driver device 103 arrives at the user's address, a complete screen may be displayed on the driver device 103 as shown in FIG. 3C. The driver may click the option “I have delivered the order” when the delivery was completed. The driver device 103 then sends to the server 127 a notification that the delivery was successful. The server 127 then stores this into the data storage 125 and updates the data storage 125 to reflect this transaction. For example, each inventory of the virtual stores are updated and sales information is recorded in the data storage 125. The driver may click the option “Cancel Delivery” when the delivery was cancelled or not completed, and in turn the server 127 then stores this information in the data storage 125 and update the data storage 125 accordingly.

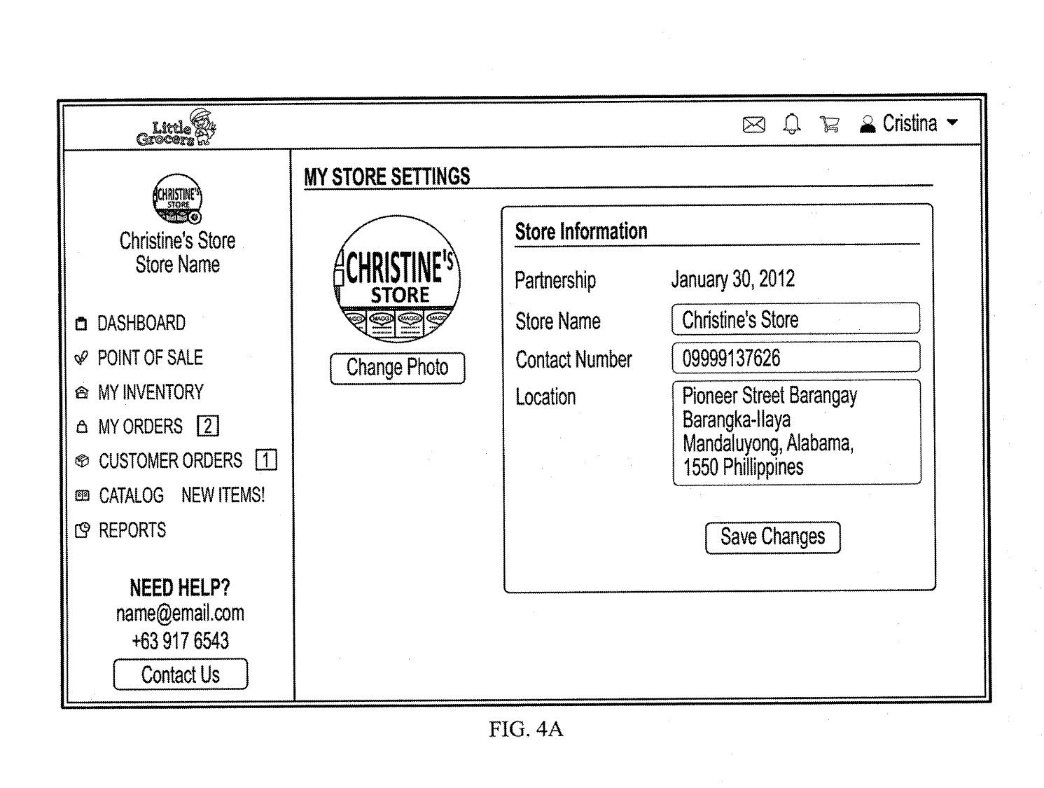

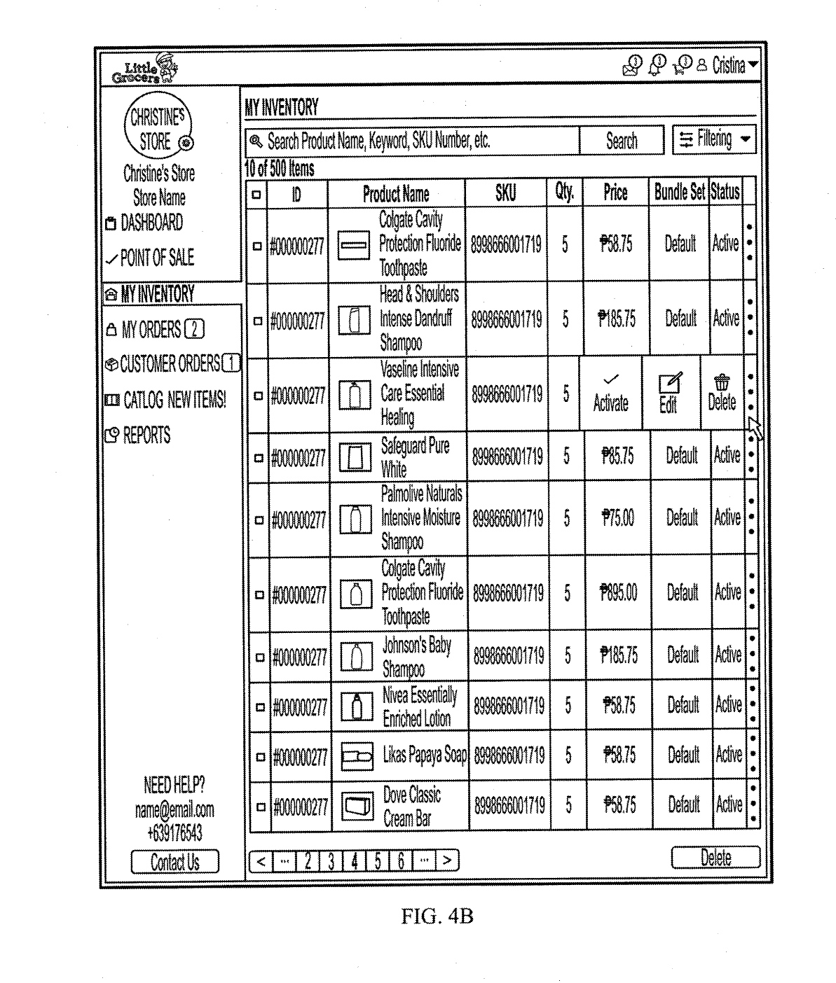

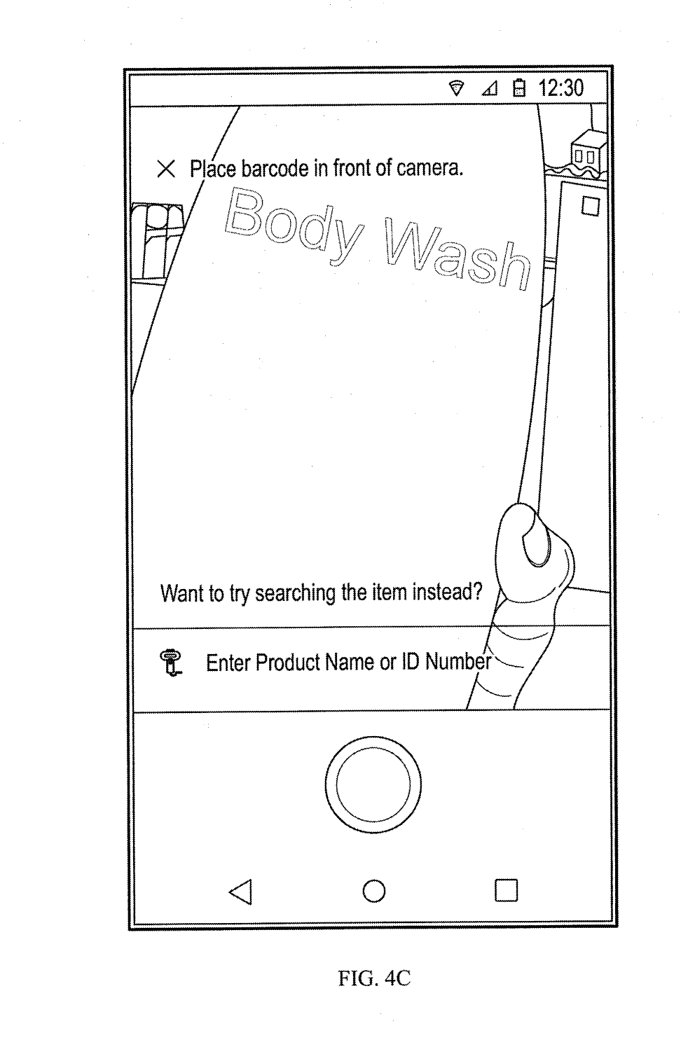

Referring to FIG. 4A, there is seen an exemplary store setting webpage for a virtual store device 101 according to one embodiment of the invention. Virtual stores used herein are home-based or store-based entities of the community-based virtual stores which have their own set of Geo-tagged inventory items and are connected to the overall online network of virtual stores and community-based physical stores and/or warehouses. The virtual store device 101 may access LittleGrocers designed for virtual stores, which comprises dashboard, point of sale (POS), my inventory, my orders, customer orders, catalog, and reports. A store manager may input information such as the store name, contact number, and location of the store in the boxes on the “MY STORE SETTINGS” page as shown in FIG. 4A. A mobile phone or tablet may also be served as the Point of Sale (POS) mechanism for the virtual stores. The server 127 receives the store information and stores it in the data storage 125. The store information may be used, e.g., when a user finds a nearby virtual store or when the location of the store is displayed on the map.

Referring to FIG. 4B, there is seen an exemplary inventory webpage for a virtual store device 101 according to one embodiment of the invention. Items in respective virtual stores may be shown in the webpage “MY INVENTORY.” Each item may be manually input into or removed from inventory of the virtual store, or a scanner or device with scanning function can be used to scan barcodes of items (or other types of codes) to update the inventory of each of the virtual stores. An app for a virtual store device 101, which may show dashboard, point of sale, my inventory, my orders, customer orders, catalog, and reports, may be provided to the virtual store device 101. The app for a virtual store device 101 may have a scanning function to scan a barcode of an item as shown in FIG. 4C. The barcode contains product information such as ID, name, SKU (stock keeping unit), price, status, and others. The virtual stores may sell items to users and also purchase items through LittleGrocers. The server 127 may be configured to update the inventory of a virtual store when the virtual store purchases items from LittleGrocers.

In one embodiment, the invention (the computer software) uses GPS (geographic positioning system) to geo-tag the location of the virtual stores, its customers, and every item in the inventory. GPS is also used to geo-tag or monitor the location of its delivery personnel and their respective vehicles.

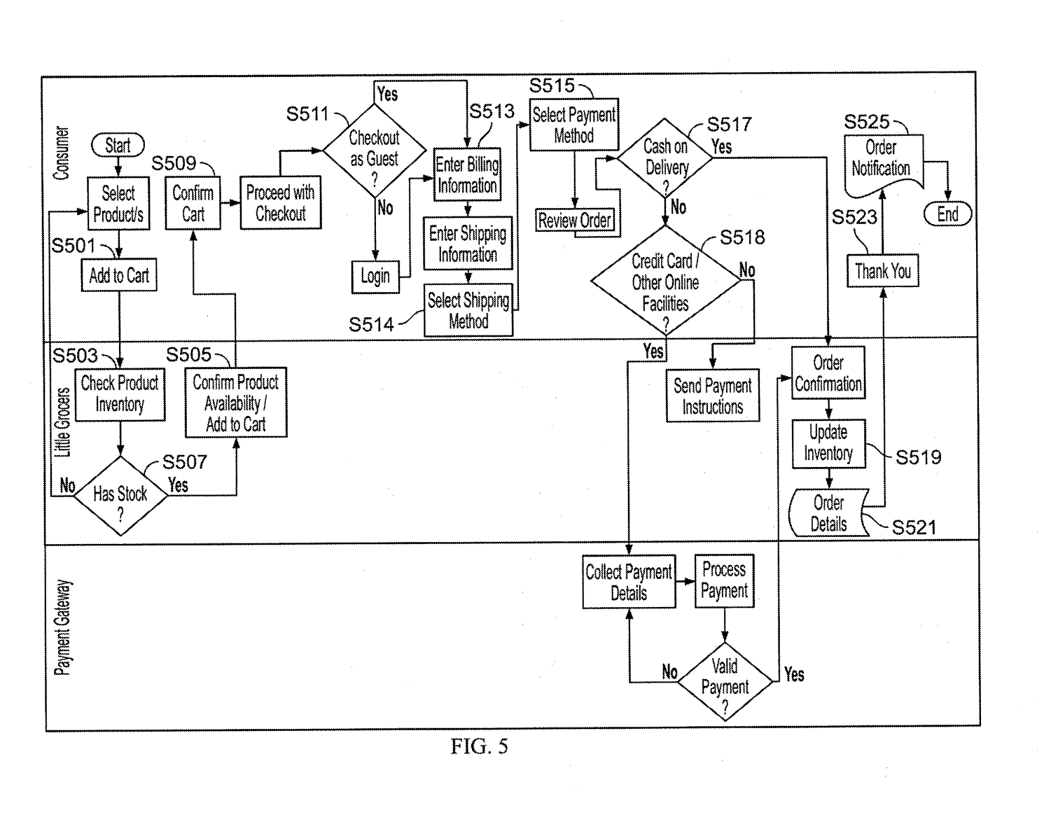

Referring to FIG. 5, there is seen a flow chart of a consumer transaction. A user using a user device 105 selects one or more products for purchasing on the webpage provided for the user (S501). Upon confirmation, product availability checking will be done by the server 127 through the “master inventory” (S503). The “master inventory” may be an inventory that combines every inventory of all the virtual stores and/or inventories of stores that are in partnership with the service provider of LittleGrocers. If the chosen product is available, it will be added to the user's virtual cart (S505). Otherwise, a notification will be sent to the user device 105 to select another product (S507). The user through the user device 105 confirms the content of the cart and proceeds with the checkout process (S509). The user will be asked to login as a Returning Customer or proceed as a Guest Customer if the user has not yet logged in to LittleGrocers (S511). New users have the option to register as well. The user enters the billing and shipping information (S513). A shipping method will be selected to determine the mode of delivery (S514). The user selects the preferred payment method, which may be Cash on Delivery (COD), Online Payment, and Over-the-Counter (OTC) payment (S515). For COD transactions, an order confirmation will come next in the process (S517). For Online Payments, the user will be redirected to the payment facility of the selected service provider and then proceed with the payment transaction (S518). Service providers are responsible for validating the payment. For OTC transactions, payment instructions will be prepared for the user. Once payment has been selected or confirmed (for online payments) the order confirmation will be processed (S519). The system 100 will update the inventory and create an order reference (S521). The system 100 redirects the user to a Thank You webpage containing the Order Reference Number (S523). The user receives a notification from the system 100 as confirmation for the order transaction (S525).

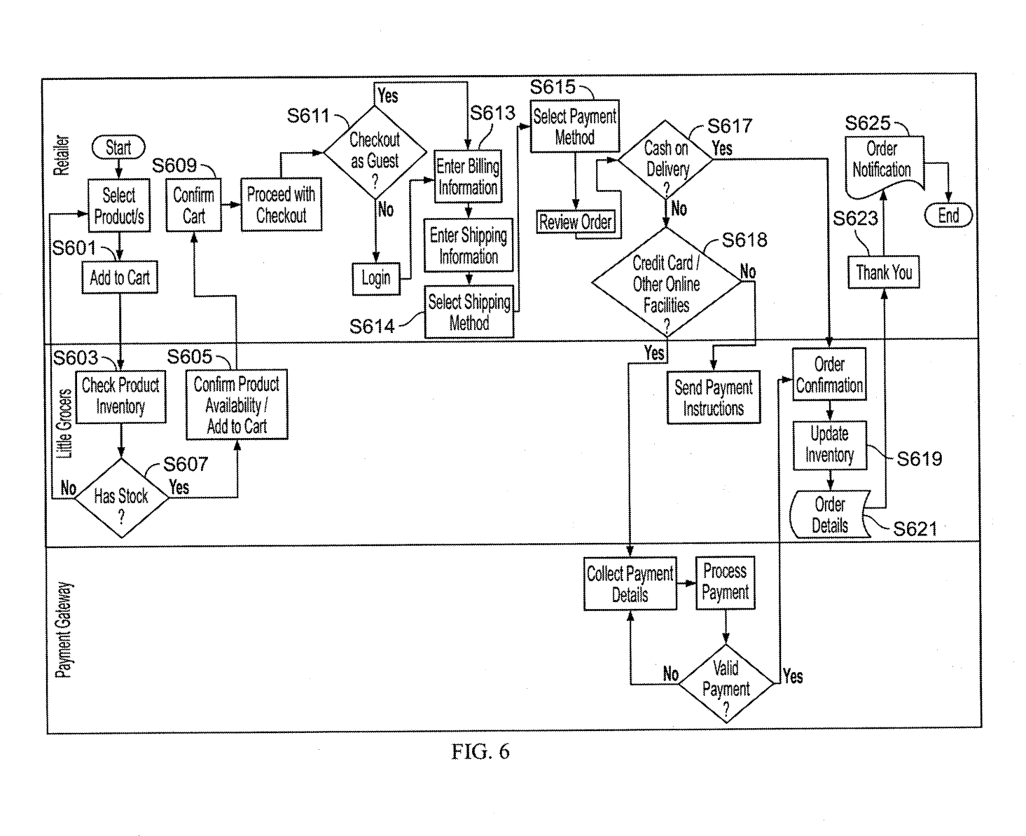

Referring to FIG. 6, there is seen an exemplary flowchart of a virtual store or retailer transaction. A virtual store or retailer, such as department stores, discount stores, supermarket, warehouse stores, mom and pop stores, etc., selects one or more products for purchasing, using the virtual store device 101 (S601). Upon confirmation, product availability checking will be done by the server 127 through the master inventory (S603). If the product is available, it will be added to the retailer's virtual cart (S605). Otherwise, a notification will be sent to the retailer at virtual store device 101 to select another product (S607). The retailer confirms the content of the cart and proceeds with the checkout process (S609). The retailer will be asked to login as a Returning Customer or proceed as a Guest Customer (S611). Retailers have the option to register as well. The retailer enters the billing and shipping information (S613). A shipping method will be selected to determine the mode of delivery (S614). The retailer selects the preferred payment method, which may be Cash on Delivery (COD), Online Payment, or Over-the-Counter (OTC) payment (S615). For COD transactions, order confirmation will come next in the process (S617). For Online Payments, the retailer will be redirected to the payment facility of the selected service provider and proceed with the payment transaction (S618). Service providers are responsible for validating the payment. For OTC transactions, payment instructions will be prepared for the retailer. Once a payment method has been selected or confirmed (for online payments), order confirmation will be processed (S619). The system 100 will update the inventory and create an order reference (S621). The system 100 redirects the retailer to a Thank You webpage containing the Order Reference Number (S623). The retailer receives a notification from the system 100 as confirmation for the order transaction (S625).

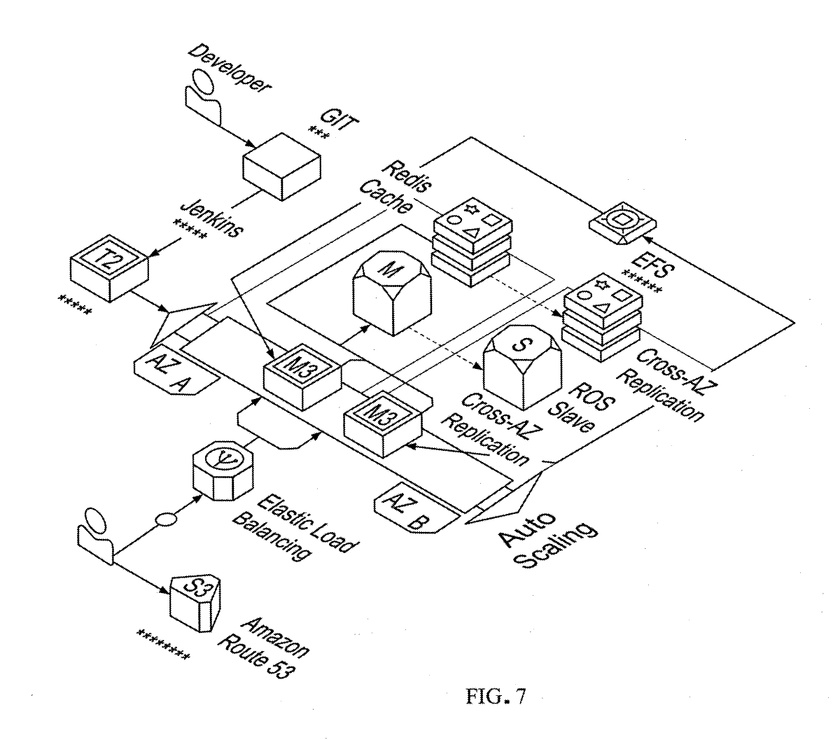

Referring to FIG. 7, there is seen an exemplary implementation of the system using the Amazon Web Services (AWS) according to one embodiment. A virtual private cloud (VPC) may be configured with two subnets in multiple Availability Zones. Each subnet may be configured with a private and public subnet. MySQL database engine may be deployed via Amazon Relational Database Service (RDS). An Amazon ElastiCache cluster with the Redis cache engine may be launched in the private subnets. Auto Scaling may be enabled to automatically increase capacity if there is a demand spike, and to reduce capacity during low traffic times. An Identity and Access Management (IAM) instance role with fine-grained permissions for access to AWS services is used for the deployment process. Appropriate security groups for each instance or function may restrict access to only necessary protocols and ports. Amazon Elastic Compute Cloud (Amazon EC2) web server instances are launched in the private subnets. Elastic Load Balancing may be deployed to automatically distribute traffic across the multiple web server instances. Jenkins is an open-source automation software predominantly used for CI/CD (Continuous Integration/Continuous Deployment). AWS CodeCommit is a secure, highly scalable, managed source control service that hosts private Git repositories. Git is a version-control system for tracking changes in computer files and coordinating work on those files among multiple people.

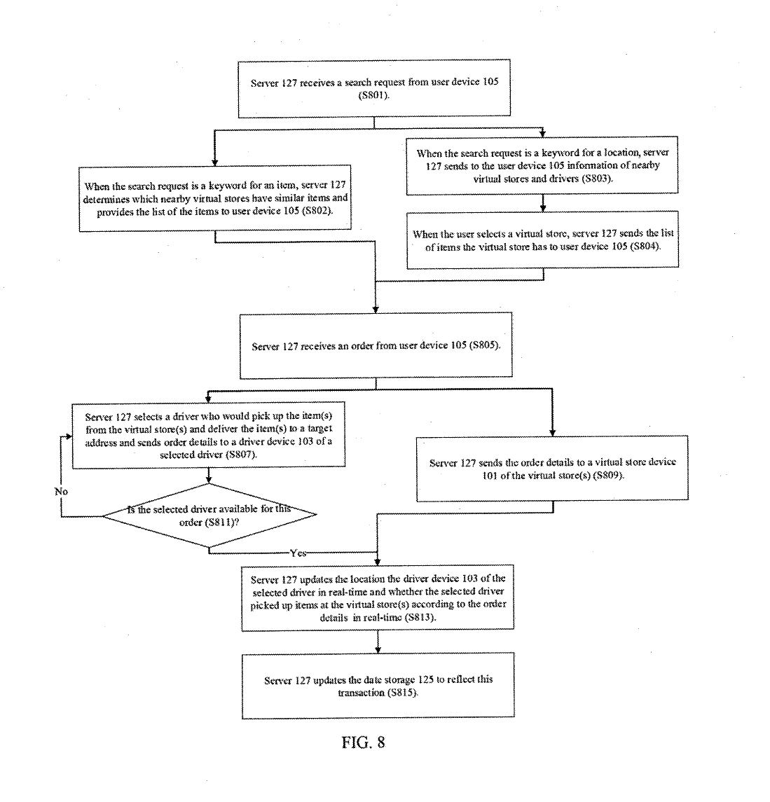

Referring to FIG. 8, there is seen a flowchart of an online sale for the device communication module 116 of the server 127 according to an exemplary embodiment. This shows an exemplary embodiment of the server 127 communicating with one or more of the virtual store device 101, the driver device 103, the user device 105, or apps downloaded thereon. In FIG. 8, the server 127 receives a search request from the user device 105 (S801). The search request may be a keyword of an item or a location. When the search request is a keyword for an item, the server 127 determines which nearby virtual stores have similar items and provides the list of the items to the user device 105 (S802). The server 127 then sends information of the items and virtual stores to the user device 105. When the search request is a keyword for a location, the server 127 collects information of virtual stores and drivers near the location and sends this information to the user device 105 (S803). This information may be presented to the user as a map where nearby virtual stores and drivers are shown. When the user clicks on a virtual store on the map or selects a virtual store in any other method, the server 127 sends the list of items the selected virtual store has to the user device 105 (S804). The user may put items in the virtual cart or proceed with checkout. The server 127 receives an order from the user device 105 (S805). The server selects a driver who would pick up the items(s) from the virtual store(s) and deliver the item(s) to a target address according to the order details, and sends the order details to a driver device 103 of a selected driver (S807). The server 127 determines whether the selected driver can take or accept this task based on, e.g., an input from the selected driver (S811). If the selected driver cannot take this task, then the server 127 selects another driver and send the order details to the another driver (S807). The server 127 sends the order details to a virtual store device 101 of the virtual store(s) (S809). The server 127 continuously updates the location of the driver device 103 of the selected driver in real-time and whether the selected driver picked up the items at the virtual store(s) according to the order details in real-time (S813). The server 127 updates the data storage 125 to reflect this transaction (S815).

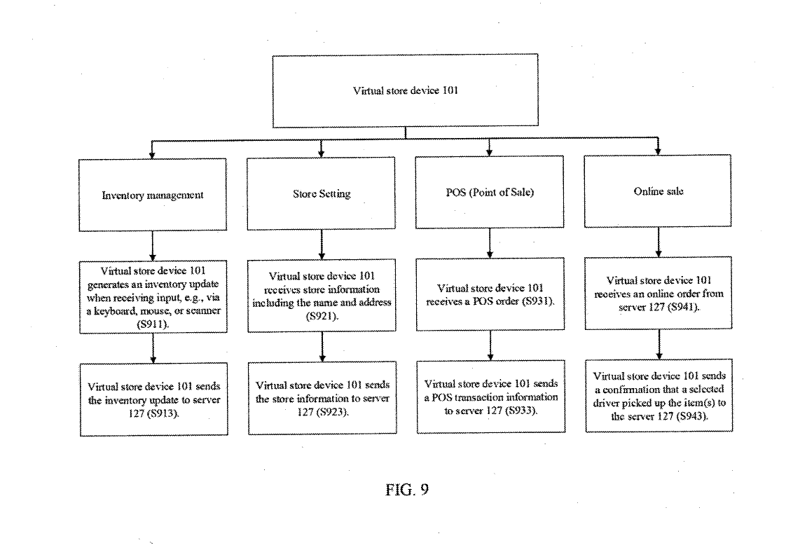

Referring to FIG. 9, there is seen a flow chart for the virtual store device 101 according to an exemplary embodiment. The virtual store device 101 can manage the inventory of the virtual store. The virtual store device 101 may generate an inventory update when receiving input, e.g., via a keyboard, a mouse, or a scanner (S911). For example, the store manager may scan a bar code of an item to update the data storage 125 of the server 127 to indicate that the virtual store now have one more of that item in the inventory. The virtual store device 101 sends the inventory update to server 127 (S913).

Still referring to FIG. 9, the virtual store device 101 may receive store information including the name and address of the virtual store (S921). For example, the store manager can input the name and the address of the store in a box on a webpage on the virtual store device 101. The virtual store device 101 then sends the store information to the server (S923).

As shown in FIG. 9, the virtual store device 101 may sell items from its location. A customer may come into the store, choose items, and pay for them at the store. The virtual store device 101 receives a POS (Point of Sale) order from the store manager (S931). The virtual store device 101 then sends a POS transaction information to the server 127 (S933). The server may update the date storage 125 to record this transaction.

Still referring to FIG. 9, the virtual store device 101 may sell items online. The virtual store device 101 may receive an online order from the server 127 (S941). The online order is generated by the user device 101, and the server 127 receives it and sends it to the virtual store device 101. When a driver comes into the store and picks up the item(s), the virtual store device 101 may send a confirmation to the server 127 that the driver picked up the item(s) (S943). The server 127 updates the data storage 125 to reflect this transaction.

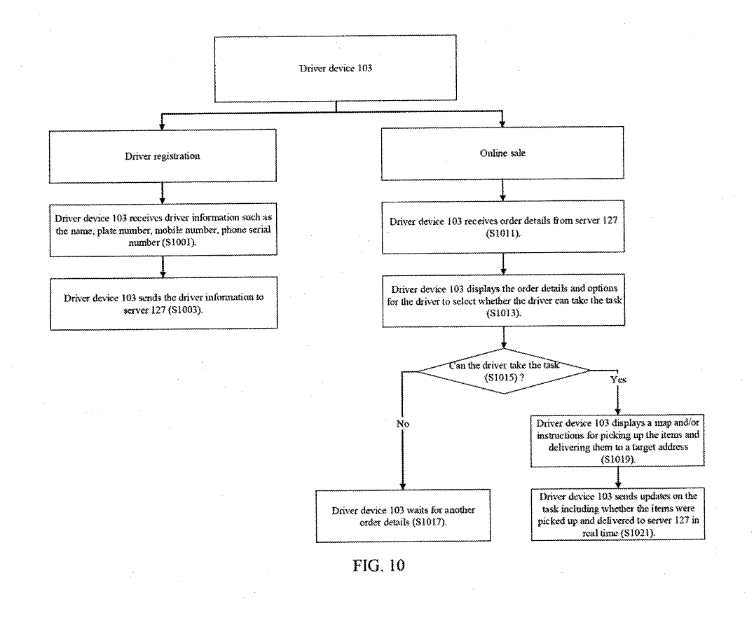

Referring to FIG. 10, there is seen a flow chart for the driver device 103 according to an exemplary embodiment. A driver may register for LittleGrocers through the driver device 103. The driver may input his or her name, mobile number, phone serial number, the plate number of vehicle, etc. (S1001). The driver device 103 sends the driver information to the server 127 (S1003).

Still referring to FIG. 10, the driver device 103 may receive order details from the server 127 (S1011). The order details are generated by the user device 105, sent to the server 127, and the server 127 sends the order details to the driver device 103. The driver device 103 displays the order details and options for the driver to select whether the driver can take the task (S1013). The driver device 103 receives the driver's input on whether he or she can take or accept the task (S1015). If the driver chooses not to take the task, then the driver device 103 waits for another order details (S1017). If the driver choose to the takes, then the drive device 103 displays a map and/or instructions for picking up the items and delivering them to a target address (S1019). The driver device 103 sends updates on the task to the server 127 in real time (S1021).

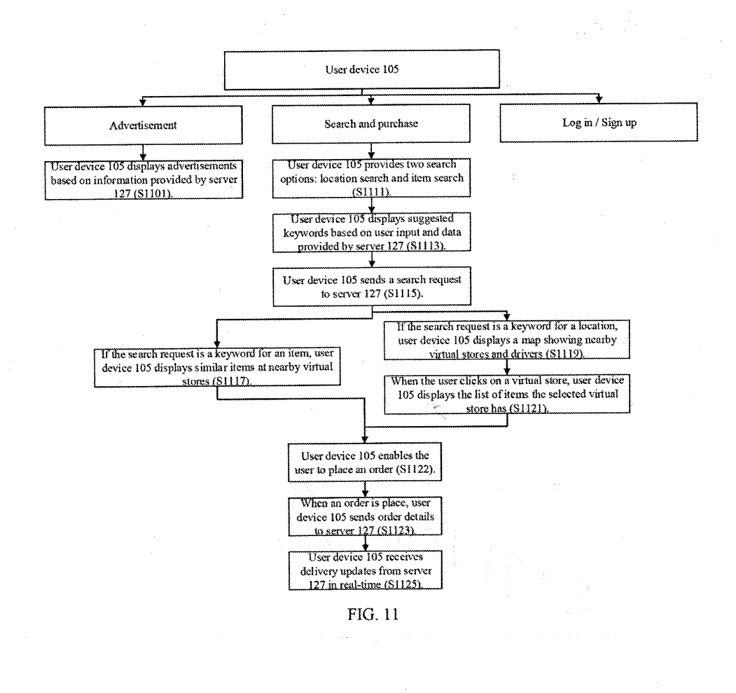

Referring to FIG. 11, there is seen a flow chart for the user device 105 according to an exemplary embodiment. The user device 105 may display advertisements based on information provided by the server 127 (S1101). The server 127 may determine which advertisements to display on the user device 105 based on the user's interest, nearby virtual stores, etc. The user device 105 may provide two search options to the user: a location search and an item search (S1111). The user may type in a search box a user input. The user device 105 may display suggested keywords based on the user input and data provided by the server 127 (S1113). The user device 105 sends a search request to the server 127 (S1115). If the search request is a keyword for an item, the user device 105 may display similar items available at nearby virtual stores (S1117). This information can come from the server 127. If the search request is a keyword for a location or a zip code, the user device 105 may display a map or a list showing nearby virtual stores and drivers (S1119). This information can come from the server 127. The term “nearby” may mean “within a predetermined distance from a target address.” When the user clicks on or selects a virtual store displayed in S1119, the user device 105 may display the list of items the selected virtual store has (S1121). When the user places a purchase order, the user device 105 sends order details to server 127 (S1123). The user device 105 receives delivery updates from the server 127 in real time (S1125).

### Embodiments

In one embodiment, there is provided a system for community-based virtual stores, comprising: a virtual store device; a driver device; a user device; and a server, the server comprising: a processor, a data storage, and a Geo-Tag module, wherein the Geo-Tag module is configured to keep track of locations of the virtual store device, the driver device, and the user device.

Preferably, the Geo-Tag module is configured to calculate routes for drivers to pick up an item from a virtual store and deliver the item to a target address.

In a preferred embodiment, the user device is configured to display a location of a virtual store and a target address based on location information stored in the data storage of the server.

In another embodiment, the user device is configured to display a map on which a location of a virtual store, a location of a driver device, and a target address are shown in real-time.

In still another embodiment, the virtual store device is configured to display a list of items currently stored in an inventory of a virtual store using the virtual store device based on inventory information stored in the data storage of the server.

In yet another embodiment, the virtual store device is configured to scan a barcode, a QR code, or other code of an item to update inventory information stored in the data storage of the server.

In another preferred embodiment, the server further comprises a gamification module that is configured to display a character or characters moving or dancing when a purchase is made by a user.

In still another preferred embodiment, the server further comprises a device communication module, wherein the device communication module is configured to: (i) if a keyword of a search request from the user device is for an item of interest, determine which nearby virtual stores have items similar to the item of interest and provide a list of the items to the user device, (ii) if the keyword of the search request from the user device is for a location of interest, provide information of nearby virtual stores and drivers to the user device, (iii) select a driver who would pick up ordered item or items from stores according to order details, and (iv) send the order details to at least one virtual store device according to the order details.

In still another preferred embodiment, there is provided a system for community-based virtual stores, comprising: a virtual store device; a driver device; a user device; and a server, the server comprising: a processor, a data storage, and a Geo-Tag module, wherein the Geo-Tag module is configured to keep track of locations of the virtual store device, the driver device, and the user device and to calculate routes for drivers to pick up an item from virtual stores and deliver the item to a target address; wherein the user device is configured to display a location of the virtual store and an address of a user based on location information stored in the data storage of the server, wherein the user device is configured to display a map on which the location of the virtual store, a location of a driver device, and the address of the user are shown in real-time, wherein the virtual store device is configured to display a list of items currently stored in an inventory of a virtual store using the virtual store device based on inventory information stored in the data storage of the server, wherein the virtual store device is configured to scan a barcode of a store item to update inventory information stored in the data storage of the server, wherein the server further comprises a gamification module that is configured to display a graphic such as a character or characters moving or dancing when a purchase is made by the user, wherein the server further comprises a device communication module, and wherein the device communication module is configured to: (i) if a keyword of a search request from the user device is for an item of interest, determine which nearby virtual stores have items similar to the item of interest and provide a list of the items to the user device, (ii) if the keyword of the search request from the user device is for a location of interest, provide information of nearby virtual stores and drivers to the user device, (iii) select a driver who would pick up ordered item or items from stores according to order details, and (iv) send the order details to at least one virtual store device according to the order details.

In another aspect, there is provided a method for community-based virtual stores, comprising: providing the system for community-based virtual stores; and receiving by the server an order from the user device; and sending by the server order information to the virtual store device and the driver device.

In another embodiment, the method comprises updating by the Geo-Tag module locations of driver devices in real-time in the data storage; displaying on the user device a location of a virtual store using the virtual store device, a current location of the driver device, and a target address.

In one embodiment, communication facility via chat or private message is available for fast and immediate interaction among all parties concerned.

In a preferred embodiment, a News Feed feature may be shown on a webpage to a user device 105 for a user or a virtual store device 101 for a retailer to show what goods might interest him or her. This News Feed is customized according to each member's profile or wants or needs.

In another embodiment, items sold at virtual stores are directly sourced from manufacturers, thereby reducing or eliminating the additional mark-ups from middle-men, and in the process the virtual stores is able to sell its goods at the lowest possible price points.

In another preferred embodiment, a built-in advertisement may be displayed on the website of the service provider in the form of avatars for each registered user, retailer, or manufacturer. The avatars of each manufacturer of goods sold on the website can interact with the consumer/shopper using the software platform.

Preferably, the invention can use any computer or mobile device, which can run a browser software (e.g., Chrome, Edge, Firefox, Safari, or others) over the Internet. The computer software may use any device, which runs, e.g., Android and Apple iOS operating systems (or others) with access to the Internet. The computer software preferably is used with a device that has a touch-screen user interface, but the invention is not limited to this. The computer software, by default, is geographic-location aware and sensitive to be able to give relevant information to its members—i.e., location based services.

In still another embodiment, the invention can store all the information on a block-chain to build complete trust and confidence from all its users.

In yet another embodiment, each of the virtual store device 101, the driver device 103, the user device 105, and the server 127 has suitable authentication processes to authenticate user login.

The present invention or any part(s) or function(s) thereof, including, e.g., the virtual store device 101, the driver device 103, the user device 105, and the server 127, including but not limited to the modules 109, 111, 113, 115, and 116 may be implemented using hardware, software, or a combination thereof, and may be implemented in one or more computer systems or other processing systems. A computer system for performing the operations of the present invention and capable of carrying out the functionality described herein can include one or more processors connected to a communications infrastructure (e.g., a communications bus, a cross-over bar, or a network). Various software embodiments are described in terms of such an exemplary computer system. After reading this description, it will become apparent to a person skilled in the relevant art(s) how to implement the invention using other computer systems and/or architectures.

The computer system can include a display interface that forwards graphics, text, and other data from the communication infrastructure (or from a frame buffer) for display on a display unit. The display interface can communicate with a browser. The computer system also includes a main memory, preferably a random access memory, and may also include a secondary memory and a database. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. The removable storage unit can represent a floppy disk, magnetic tape, optical disk, etc. which is read by and written to by the removable storage drive. As will be appreciated, the removable storage unit can include a computer usable storage medium having stored therein computer software and/or data.

The computer system may also include a communications interface which allows software and data to be transferred between the computer system and external devices. The terms “computer program medium” and “computer usable medium” are used to refer generally to media such as the removable storage drive, a hard disk installed in the hard disk drive, and signals. The invention can be implemented on those. These computer program products provide software to the computer system.

Computer programs or control logic are stored in the main memory and/or the secondary memory. Computer programs may also be received via the communications interface. Such computer programs or control logic (software), when executed, cause the computer system or its processor to perform the features and functions of the present invention, as discussed herein.

While the invention has been particularly shown and described with respect to preferred embodiment(s) thereof, it should be understood that the embodiment(s) have been presented by way of example, and not limitation. It will be apparent to persons skilled in the relevant art(s) that various changes in form and detail can be made therein without departing from the spirit and scope of the present invention. Thus, the present invention should not be limited by any above-described exemplary embodiment.

What is claimed is:

1. A system for community-based virtual stores, comprising:
a server, the server comprising:
(i) at least one processor,
(ii) a data storage,
(iii) a geo-tag module, and
(iv) a device communication module,
wherein the geo-tag module is configured to:
keep track of current locations of driver devices,
wherein the device communication module is configured to:
receive a search request and an order from a user device,
select a driver who would pick up an ordered item from a virtual store and deliver the ordered item to a target address based at least on order details and driver locations,
send order details to a driver device of a selected driver and to a virtual store device of the virtual store,
receive a driver confirmation from the selected driver, and
reselect another driver if the driver confirmation indicates that the selected driver cannot deliver the ordered item based at least on order details and driver locations.

2. The system according to claim 1, further comprising:
a virtual store device,
wherein the virtual store device is configured to generate an inventory update when receiving an input from a user and send the inventory update to the server,
wherein the server is configured to update the data storage according to the inventory update.

3. The system according to claim 2, wherein the virtual store device is further configured to receive store information from the user and send the store information to the server, wherein the server is configured to update the data storage to reflect according to the store information.

4. The system according to claim 3, wherein the virtual store device is further configured to receive a Point-of-Sale (POS) order and sends a POS transaction information to the server.

5. The system according to claim 4, wherein the virtual store device is further configured to receive the order details from the server, and send a confirmation that the selected driver pricked up the order item to the server.

6. The system according to claim 5, further comprising:
a driver device,
wherein the driver device is configured to receive driver information from a driver, wherein the driver information comprises a name, a plate number, a mobile number, and a phone serial number, and send the driver information to the server.

7. The system according to claim 6, wherein the driver device is further configured to:
receive the order details from the server, and
display the order details and options for the selected driver to select whether the selected driver can take this order.

8. The system according to claim 7, wherein the driver device is further configured to:
display a map and/or instruction for picking up the ordered item and deliver the order item to the target address, and
update a location of the driver device in real-time.

9. The system according to claim 8, further comprising:
a user device,
wherein the user device is configured to:
provide two search options, the two search options including a location search and an item search, and
send a search request inputted by the user to the server.

10. The system according to claim 9, wherein the user device is further configured to:
display a list of items that are similar to an item related to a keyword in the search request when the item search is chosen, and
display a map showing virtual stores near a location related to the keyword in the search request when the location search is chosen.

11. The system according to claim 10, wherein the user device is further configured to:
send order details to the server, and
receive delivery updates from the server.

12. A method for community-based virtual stores, comprising:
receiving by a server a search request for an item from a user device;
determining by the server which nearby virtual stores have items related to the item search request and providing a list of items related to the item search request to the user device;
receiving by the sever a search request for a location from the user device;
sending by the server information of nearby stores related to the location search request to the user device; and
sending by the server a list of items a selected virtual store has to the user device.

13. The method according to claim 12, further comprising,
receiving by a server having at least one processor and a data storage order details from the user device;
selecting by the server a driver who would pick up an ordered item or ordered items from a virtual store or virtual store(s) to a target address according the order details, based at least on current locations of drivers;
sending the order details to a driver device of a selected driver; and
reselecting by the sever another driver when the selected driver sends a confirmation that the selected driver cannot deliver the ordered item(s) based at least on the current locations of drivers.

14. The method according to claim 13, further comprising:
sending by the server the order details to a virtual store device of virtual store(s) according to the order details.

15. The method according to claim 14, further comprising:
updating the storage according to the order details.

16. A non-transitory computer-readable storage medium storing a program, which, when executed by the system according to claim 1, performs the following steps:
receiving by the server an order from a user device;
sending by the server order details to a virtual store device and a driver device;
updating by the Geo-Tag module locations of driver devices in real-time in the data storage; and
displaying on the user device a location of a virtual store, a current location of the driver device, and a target address.
